(19) United States
(12) Patent Application Publication
(10) Pub. No.: US 2025/0146552 A1
(43) Pub. Date: May 8, 2025

(54) TUBULAR VIBRATION ISOLATION DEVICE FOR MOTOR MOUNT

(71) Applicant: Sumitomo Riko Company Limited, Aichi (JP)

(72) Inventors: Hirotaka Matsui, Aichi (JP); Mutsumi Muraoka, Aichi (JP); Satoshi Umemura, Aichi (JP)

(73) Assignee: Sumitomo Riko Company Limited, Aichi (JP)

(21) Appl. No.: 19/015,700

(22) Filed: Jan. 10, 2025

Related U.S. Application Data
(63) Continuation of application No. PCT/JP2023/040789, filed on Nov. 13, 2023.

(30) Foreign Application Priority Data
Dec. 8, 2022 (JP) 2022-196324

(51) Int. Cl. F16F 1/387; B60K 1/00; F16F 1/38; F16F 15/08

(52) U.S. Cl. CPC F16F 1/387; B60K 1/00; F16F 1/3835; F16F 15/08; F16F 2228/04; F16F 2230/02

(57) ABSTRACT

A tubular vibration isolation device for a motor mount includes an inner shaft member and an outer tubular member that are connected by a main body rubber elastomer. The main body rubber elastomer includes rubber legs that extend from the inner shaft member toward the outer tubular member to connect the inner shaft member and the outer tubular member to each other. The rubber leg is provided with vibration damping protrusions that protrude on a surface and are located at an intermediate portion separated from both the inner shaft member and the outer tubular member in a connecting direction. The vibration damping protrusions are disposed in parallel and separated from each other in the connecting direction of the rubber leg.

### CROSS-REFERENCE TO RELATED APPLICATION

The present application is a continuation of PCT/JP2023/040789, filed on Nov. 13, 2023, and is related to and claims priority from Japanese patent application no. 2022-196324, filed on Dec. 8, 2022. The entire contents of the aforementioned application are hereby incorporated by reference herein.

### BACKGROUND

### Technical Field

The disclosure relates to a tubular vibration isolation device for a motor mount that supports and isolates vibration for a drive electric motor in an environmentally friendly automobile such as an electric vehicle.

### Related Art

In recent years, against the background of increasing concern for environmental issues, environmentally friendly automobiles adopting electric motors as power sources instead of internal combustion engines have been proposed.

A vibration isolation device for a motor mount that supports and isolates vibration for a power unit including an electric motor requires properties significantly different from a vibration isolation device for an engine mount that supports and isolates vibration for a conventional internal combustion engine. Thus, development of vibration isolation devices more suitable for motor mounts is progressing. For example, in International Patent Application Publication No. 2020/175640, the present applicant has proposed a tubular vibration isolation device for a motor mount that includes a countermeasure structure against high-frequency vibrations, which is an issue in motor mounts.

However, the tubular vibration isolation device for a motor mount is still in the process of development, and there is room for further improvement, especially in terms of countermeasures against high-frequency vibrations (e.g., a high dynamic spring action due to rubber surging).

### SUMMARY

Hereinafter, aspects for understanding the disclosure will be described. However, each aspect described below is exemplary and may be adopted in combination with each other as appropriate. In addition, a plurality of components described in each aspect may be recognized and adopted independently wherever possible, and may also be adopted in combination with any component described in other aspects. Accordingly, in the disclosure, various other aspects may be realized without being limited to the aspects described below.

First Aspect is a tubular vibration isolation device for a motor mount, including an inner shaft member and an outer tubular member that are connected by a main body rubber elastomer. The main body rubber elastomer includes a plurality of rubber legs that extend from the inner shaft member toward the outer tubular member to connect the inner shaft member and the outer tubular member to each other. The rubber leg is provided with a plurality of vibration damping protrusions that protrude on a surface and are located at an intermediate portion separated from both the inner shaft member and the outer tubular member in a connecting direction. The plurality of vibration damping protrusions are disposed in parallel and separated from each other in the connecting direction of the rubber leg.

According to the tubular vibration isolation device for a motor mount structured in accordance with this aspect, a peak of a high dynamic spring action resulting from surging of the rubber leg is reduced by a resonance action (vibration damping action created by a dynamic damper) of the vibration damping protrusion, and improvement in quietness in a high-frequency range and the like is achieved.

Further, for example, if natural frequencies of a plurality of vibration damping protrusions provided at the rubber leg are set to be the same, a vibration damping effect against surging of the rubber leg can be advantageously obtained at a specific frequency. Further, for example, if natural frequencies different from each other are set for a plurality of vibration damping protrusions provided at the rubber leg, a vibration damping effect against surging of the rubber leg can be effectively obtained over a wider frequency range.

By disposing a plurality of vibration damping protrusions in parallel and separated from each other in the connecting direction of the rubber leg, a high degree of design freedom in the size, the shape, etc. of each vibration damping protrusion can be ensured, and an intended vibration damping effect can be more efficiently obtained. Further, for example, by disposing the vibration damping protrusion respectively at portions of the rubber leg at which the amplitude of bending deformation becomes large, vibration damping actions created by the vibration damping protrusion can be efficiently obtained against not only rubber surging of a primary vibration mode but also rubber surging of a secondary or higher-order vibration mode.

Second Aspect is the tubular vibration isolation device for a motor mount according to First Aspect, in which the plurality of vibration damping protrusions provided at the rubber leg are set with a plurality of natural frequencies different from each other.

According to the tubular vibration isolation device for a motor mount structured in accordance with this aspect, a vibration damping effect can be obtained in a wide frequency range by a plurality of vibration damping protrusions with natural frequencies different from each other, against a high dynamic spring action resulting from surging of the rubber leg.

Third Aspect is the tubular vibration isolation device for a motor mount according to Second Aspect, in which the plurality of natural frequencies different from each other are set by configuring protruding dimensions of the vibration damping protrusions protruding from the rubber leg to be different from each other.

According to the tubular vibration isolation device for a motor mount structured in accordance with this aspect, by configuring protruding dimensions of a plurality of vibration damping protrusions protruding from the rubber leg to be different from each other, natural frequencies different from each other can be easily set for the plurality of vibration damping protrusions.

Fourth Aspect is the tubular vibration isolation device for a motor mount according to Second Aspect or Third Aspect, in which the plurality of natural frequencies different from each other are set by configuring thickness dimensions in a radial direction of the vibration damping protrusions to be different from each other.

According to the tubular vibration isolation device for a motor mount structured in accordance with this aspect, natural frequencies different from each other can be easily set for a plurality of vibration damping protrusions by a difference in thickness dimensions in the radial direction of the plurality of vibration damping protrusions.

Fifth Aspect is the tubular vibration isolation device for a motor mount according to any one of First Aspect to Fourth Aspect, in which the plurality of vibration damping protrusions are disposed substantially evenly in the connecting direction of the rubber leg on the rubber leg.

According to the tubular vibration isolation device for a motor mount structured in accordance with this aspect, by disposing a plurality of vibration damping protrusions substantially evenly in the radial direction, a separation distance between each vibration damping protrusion can be ensured, and it becomes easy to set a thickness dimension in the radial direction and the like of each vibration damping protrusion with a high degree of freedom. Further, it becomes easy to dispose a plurality of vibration damping protrusions at portions of the rubber leg at which the amplitude of bending deformation becomes large in surging of a multiple-order vibration mode, and an effective vibration damping effect against secondary or higher-order surging can be obtained.

Sixth Aspect is the tubular vibration isolation device for a motor mount according to any one of First Aspect to Fifth Aspect, in which the vibration damping protrusions disposed adjacent to each other in the connecting direction of the rubber leg are separated from each other by a distance that is configured to be smaller than both of a distance from the vibration damping protrusion located at an innermost circumference to an inner circumferential end of the rubber leg, and a distance from another vibration damping protrusion located at an outermost circumference to an outer circumferential end of the rubber leg.

According to the tubular vibration isolation device for a motor mount structured in accordance with this aspect, since a plurality of vibration damping protrusions are disposed at positions close to each other in the connecting direction of the rubber leg, an excellent vibration damping effect created by cooperation of the plurality of vibration damping protrusions can be obtained against surging of the primary vibration mode of the rubber leg. Further, a vibration damping effect against surging of a multiple-order vibration mode can be efficiently obtained by the plurality of vibration damping protrusions disposed separately from each other in the connecting direction of the rubber leg.

Seventh Aspect is a tubular vibration isolation device for a motor mount, including an inner shaft member and an outer tubular member that are connected by a main body rubber elastomer. The main body rubber elastomer includes a plurality of rubber legs that extend from the inner shaft member toward the outer tubular member to connect the inner shaft member and the outer tubular member to each other. In a circumferential interval between the rubber legs adjacent to each other in a circumferential direction, a vibration damping protrusion is provided to connect the rubber legs to each other in the circumferential direction. The vibration damping protrusion has an axial dimension that is configured to be larger than a circumferential dimension at a portion located in the circumferential interval between the rubber legs.

According to the tubular vibration isolation device for a motor mount structured in accordance with this aspect, by providing the vibration damping protrusion in a circumferential interval between the rubber legs and supporting both circumferential ends of the vibration damping protrusion by the rubber legs, it becomes easy to set a resonance frequency of the vibration damping protrusion to a higher frequency. Further, since the axial dimension of the vibration damping protrusion in the circumferential interval between the rubber legs is configured to be larger than the circumferential dimension, while a large mass for the vibration damping protrusion may be set to obtain a significant vibration damping action, it also becomes easy to ensure a tuning freedom for the resonance frequency of the vibration damping protrusion to easily set to the high-frequency side.

Eighth Aspect is the tubular vibration isolation device for a motor mount according to Seventh Aspect, in which the vibration damping protrusion has both axial ends that do not protrude toward axially outward directions with respect to axial end surfaces of the rubber leg.

According to the tubular vibration isolation device for a motor mount structured in accordance with this aspect, by utilizing a space in the circumferential interval between the rubber legs to provide the vibration damping protrusion, a vibration damping effect against surging of the rubber leg can be effectively obtained while preventing an increase in size in the axial direction.

Ninth Aspect is a tubular vibration isolation device for a motor mount, including an inner shaft member and an outer tubular member that are connected by a main body rubber elastomer. The main body rubber elastomer includes a plurality of rubber legs that extend from the inner shaft member toward the outer tubular member to connect the inner shaft member and the outer tubular member to each other. The rubber leg is provided with a vibration damping protrusion that protrudes on a surface. The vibration damping protrusion extends in a connecting direction of the rubber leg.

According to the tubular vibration isolation device for a motor mount structured in accordance with this aspect, even in cases where an antinode portion in the vibration mode of surging of the rubber leg deviates from the center in the connecting direction of the rubber leg or is present at a plurality of sites, it becomes easy to provide a vibration damping protrusion to cover such an antinode portion of the vibration mode. Thus, it becomes possible to obtain a stable vibration damping effect against various types of surging in the rubber leg, and particularly, it becomes possible to obtain an effective vibration damping effect against surging of the rubber leg in a multiple-order vibration mode.

Tenth Aspect is the tubular vibration isolation device for a motor mount according to any one of First Aspect to Ninth Aspect, in which the rubber leg is configured as a solid structure that continuously extends from axial central portions of the inner shaft member and the outer tubular member toward both axial sides respectively. By providing the vibration damping protrusion to protrude from both axial end surfaces of the rubber leg toward axially outward directions respectively, the vibration damping protrusions on the both axial sides protruding from the both axial end surfaces are continuously connected in the axial direction by the rubber leg.

According to the tubular vibration isolation device for a motor mount structured in accordance with this aspect, with the rubber leg being continuous in the axial direction, stabilization of a deformation configuration of the rubber leg is achieved, and a vibration damping effect created by the vibration damping protrusions provided to protrude toward the axially outward directions from the rubber leg is stably exerted.

Eleventh Aspect is the tubular vibration isolation device for a motor mount according to any one of First Aspect to Tenth Aspect, in which the rubber leg is configured as a solid structure that continuously extends from axial central portions of the inner shaft member and the outer tubular member toward both axial sides respectively. The vibration damping protrusion protrudes from both circumferential end surfaces of the rubber leg respectively, and is continuously provided over an entire axial length of the rubber leg.

According to the tubular vibration isolation device for a motor mount structured in accordance with this aspect, with the rubber leg being continuous in the axial direction, stabilization of a deformation configuration of the rubber leg is achieved, and a vibration damping effect created by the vibration damping protrusion provided to protrude toward the circumferentially outward directions from the rubber leg is stably exerted. Further, a portion of the vibration damping protrusion that protrudes toward the circumferentially outward directions from the rubber leg is provided continuously over the entire axial length of the rubber leg, and thereby a significant vibration damping effect created by the circumferentially protruding portion of the vibration damping protrusion can be obtained.

Twelfth Aspect is the tubular vibration isolation device for a motor mount according to any one of First Aspect to Eleventh Aspect, in which the rubber leg is configured as a solid structure that continuously extends from axial central portions of the inner shaft member and the outer tubular member toward both axial sides respectively. The vibration damping protrusion protrudes from a full circumferential surface of the rubber leg and is continuously provided in an annular shape.

According to the tubular vibration isolation device for a motor mount structured in accordance with this aspect, with the rubber leg being continuous in the axial direction, stabilization of a deformation configuration of the rubber leg is achieved, and a vibration damping effect created by the vibration damping protrusion is stably exerted. Further, since the vibration damping protrusion is provided to protrude from the rubber leg on the full circumferential surface including both axial sides and both circumferential sides, a significant vibration damping effect created by the vibration damping protrusion can be obtained while suppressing a protrusion height of the vibration damping protrusion from the rubber leg.

Thirteenth Aspect is a tubular vibration isolation device for a motor mount, including an inner shaft member and an outer tubular member that are connected by a main body rubber elastomer. The main body rubber elastomer is provided with a vibration damping protrusion that protrudes on a surface and is located at an intermediate portion separated from both the inner shaft member and the outer tubular member in a radial direction. The vibration damping protrusion constitutes a first vibration damping part and a second vibration damping part with natural frequencies different from each other.

According to the tubular vibration isolation device for a motor mount structured in accordance with this aspect, with the vibration damping protrusion including the first vibration damping part and the second vibration damping part with natural frequencies different from each other, broadening of the vibration damping action (widening of the frequency range in which the vibration damping effect is exerted) exerted by the vibration damping protrusion is achieved.

Fourteenth Aspect is the tubular vibration isolation device for a motor mount according to Thirteenth Aspect, in which the first vibration damping part and the second vibration damping part are constituted by separate vibration damping protrusions.

According to the tubular vibration isolation device for a motor mount structured in accordance with this aspect, the arrangements, the shapes, the sizes, etc. of the first vibration damping part and the second vibration damping part can be set with a high degree of freedom.

Fifteenth Aspect is the tubular vibration isolation device for a motor mount according to Thirteenth Aspect, in which the first vibration damping part and the second vibration damping part are constituted by different portions of one vibration damping protrusion.

According to the tubular vibration isolation device for a motor mount structured in accordance with this aspect, an effective vibration damping action against surging can be obtained in a wider frequency range by one vibration damping protrusion. This aspect does not necessarily mean that only one vibration damping protrusion is provided. For example, a plurality of vibration damping protrusions, each including the first vibration damping part and the second vibration damping part at different portions, may be provided on the main body rubber elastomer.

Sixteenth Aspect is a tubular vibration isolation device for a motor mount, including an inner shaft member and an outer tubular member that are connected by a main body rubber elastomer. The main body rubber elastomer is provided with a vibration damping protrusion that protrudes in an axially outward direction on a surface of an axial end. The vibration damping protrusion includes a mass part that is configured to be thick at a tip portion of a protruding direction.

According to the tubular vibration isolation device for a motor mount structured in accordance with this aspect, since a mass of the vibration damping protrusion is configured to be large by the mass part configured to be thick, an intended vibration damping action can be efficiently obtained. Further, since a base portion of the vibration damping protrusion is configured to be thin compared to the tip portion, a deformation rigidity of the base portion of the vibration damping protrusion is suppressed, and deformation of the vibration damping protrusion with respect to a vibration input efficiently occurs.

According to the disclosure, improvement in a vibration isolation performance against high-frequency vibrations, which is an issue in a motor mount, can be realized.

### BRIEF DESCRIPTION OF DRAWINGS

FIG. 1 is a front view showing a motor mount as First Embodiment of the disclosure.

FIG. 2 is a cross-sectional view taken along line II-II of FIG. 1.

FIG. 3 is a front view showing a motor mount as Second Embodiment of the disclosure.

FIG. 4 is a front view showing a motor mount as Third Embodiment of the disclosure.

FIG. 5 is a front view showing a motor mount as Fourth Embodiment of the disclosure.

FIG. 6 is a front view showing a motor mount as Fifth Embodiment of the disclosure.

FIG. 7 is a front view showing a motor mount as Sixth Embodiment of the disclosure.

FIG. 8 is a front view showing a motor mount as Seventh Embodiment of the disclosure.

FIG. 9 is a front view showing a motor mount as Eighth Embodiment of the disclosure.

FIG. 10 is a cross-sectional view taken along line X-X of FIG. 9.

FIG. 11 is a front view showing a motor mount as Ninth Embodiment of the disclosure.

FIG. 12 is a front view showing a motor mount as Tenth Embodiment of the disclosure.

FIG. 13 is a cross-sectional view taken along line XIII-XIII of FIG. 12.

FIG. 14 is a front view showing a motor mount as Eleventh Embodiment of the disclosure.

FIG. 15 is a longitudinal cross-sectional view showing a motor mount as Twelfth Embodiment of the disclosure.

FIG. 16 is a front view showing a motor mount as Thirteenth Embodiment of the disclosure.

FIG. 17 is a cross-sectional view taken along line XVII-XVII of FIG. 16.

FIG. 18 is a front view showing a motor mount as Fourteenth Embodiment of the disclosure.

FIG. 19 is a cross-sectional view taken along line XIX-XIX of FIG. 18.

### DESCRIPTION OF EMBODIMENTS

Embodiments of the disclosure provide a tubular vibration isolation device for a motor mount with a novel structure capable of realizing improvement in a vibration isolation performance against high-frequency vibrations, which is an issue in a motor mount.

Hereinafter, embodiments of the disclosure will be described with reference to the drawings.

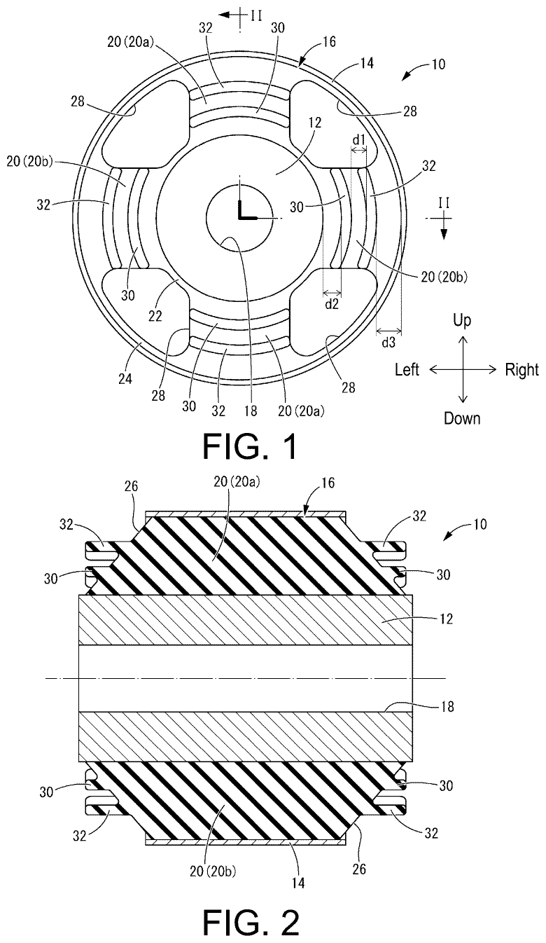

FIG. 1 and FIG. 2 show a motor mount 10 for an electric vehicle as First Embodiment of a tubular vibration isolation device for a motor mount according to the disclosure. The motor mount 10 has a structure in which an inner shaft member 12 and an outer tubular member 14 are connected by a main body rubber elastomer 16. In the following description, as a general rule, an up-down direction refers to an up-down direction in FIG. 1, a front-rear direction refers to a left-right direction in FIG. 2, and a left-right direction refers to a left-right direction in FIG. 1, respectively.

The inner shaft member 12 is a rigid member formed of metal or synthetic resin, and is configured into a substantially cylindrical shape that is thick and has a small diameter. A central hole of the inner shaft member 12 is configured as a bolt hole 18 that penetrates in an axial direction, and the inner shaft member 12 is mounted to a power unit including an electric motor by a mounting bolt (not shown) inserted through the bolt hole 18.

The outer tubular member 14 is a rigid member formed of metal or synthetic resin, and is configured into a substantially cylindrical shape that is thin and has a large diameter. The outer tubular member 14 has a length dimension in the axial direction that is configured to be smaller than the inner shaft member 12. An outer bracket (not shown) is mounted to the outer tubular member 14 in an externally fitted state, and the outer tubular member 14 is mounted to a vehicle body via the outer bracket.

The inner shaft member 12 is inserted and disposed in a separated state within an inner circumference of the outer tubular member 14, and the inner shaft member 12 and the outer tubular member 14 are connected to each other by the main body rubber elastomer 16. The main body rubber elastomer 16 of this embodiment includes four rubber legs 20, 20, 20, and 20. The rubber leg 20 extends in a radial direction from the inner shaft member 12 toward the outer tubular member 14, with an inner circumferential end vulcanization-bonded to an outer circumferential surface of the inner shaft member 12, and an outer circumferential end vulcanization-bonded to an inner circumferential surface of the outer tubular member 14. The inner circumferential ends of the rubber legs 20 are connected to each other in the circumferential direction by an inner circumferential connecting part 22 extending in the circumferential direction, and the outer circumferential ends of the rubber legs 20 are connected to each other in the circumferential direction by an outer circumferential connecting part 24 extending in the circumferential direction. The inner circumferential connecting part 22 is fixed to the outer circumferential surface of the inner shaft member 12, and the outer circumferential connecting part 24 is fixed to the inner circumferential surface of the outer tubular member 14. In this embodiment, two rubber legs 20a and 20a extend in the up-down direction on both upper and lower sides with respect to the inner shaft member 12, and the other two rubber legs 20b and 20b extend in the left-right direction on both left and right sides with respect to the inner shaft member 12. Thus, the four rubber legs 20a, 20a, 20b, and 20b are disposed in a cross shape as a whole.

As shown in FIG. 2, the rubber leg 20 excluding an inner circumferential vibration damping protrusion 30 and an outer circumferential vibration damping protrusion 32 (to be described later) has both axial end surfaces each configured as a tapered surface 26 that is inclined to an axially inward direction toward the outer circumference, and has an outer dimension in the axial direction that is small toward the outer circumference. The rubber leg 20 has no recess or void midway in the axial direction, and is configured as a solid structure that extends continuously from axial central portions of the inner shaft member 12 and the outer tubular member 14 toward both axial sides.

A void 28 that penetrates in the axial direction is formed between two rubber legs 20 and 20 adjacent to each other in the circumferential direction. The void 28 is configured into a hole shape that takes the rubber legs 20 and 20, the inner circumferential connecting part 22, and the outer circumferential connecting part 24 as a circumferential wall. Since the void 28 is formed in a circumferential interval between the rubber leg 20 extending in the up-down direction and the rubber leg 20 extending in the left-right direction, the void 28 is configured into a hole cross-sectional shape that widens in the circumferential direction toward the outer circumference as a whole. In this embodiment, since the outer circumferential end of the rubber leg 20 is configured into a spreading shape that widens to circumferentially outer sides toward the outer circumference, an outer circumferential end of the void 28 becomes narrow in the circumferential direction toward the outer circumference.

An inner circumferential vibration damping protrusion 30 serving as a vibration damping protrusion is integrally formed at the rubber leg 20. The inner circumferential vibration damping protrusion 30 is configured into a curved plate shape that curves in the circumferential direction, and protrudes toward an axially outward direction from the axial end surface of the rubber leg 20. The inner circumferential vibration damping protrusion 30 extends in a straight line in the axial direction with an a substantially constant cross-sectional shape. A protruding tip surface of the inner circumferential vibration damping protrusion 30 is configured into a planar shape extending substantially perpendicularly to the axis. In an extending direction of the rubber leg 20 (i.e., a connecting direction of the rubber leg 20 connecting the inner shaft member 12 and the outer tubular member 14), the inner circumferential vibration damping protrusion 30 is located at an intermediate portion away from both the inner shaft member 12 and the outer tubular member 14, and is suitably disposed on the inner circumferential side of a center of the rubber leg 20. The inner circumferential vibration damping protrusion 30 is provided at each of the rubber legs 20, and is provided on both axial sides to protrude from both axial end surfaces of each rubber leg 20. The inner circumferential vibration damping protrusions 30 and 30 protruding in both axially outward directions from the rubber leg 20 are disposed at radial positions corresponding to each other, and these inner circumferential vibration damping protrusions 30 and 30 on both axial sides are continuously connected in the axial direction by the solidly configured rubber leg 20. The inner circumferential vibration damping protrusions 30 provided at the four rubber legs 20a, 20a, 20b, and 20b are disposed on a substantially same circumference.

An outer circumferential vibration damping protrusion 32 is integrally formed as a vibration damping protrusion at the rubber leg 20. The outer circumferential vibration damping protrusion 32 is configured into a curved plate shape that curves in the circumferential direction, and protrudes toward the axially outward direction from the axial end surface of the rubber leg 20. The outer circumferential vibration damping protrusion 32 extends in a straight line in the axial direction with a substantially constant cross-sectional shape. A protruding tip surface of the outer circumferential vibration damping protrusion 32 is configured into a planar shape extending substantially perpendicularly to the axis. In the extending direction of the rubber leg 20, the outer circumferential vibration damping protrusion 32 is located at an intermediate portion away from both the inner shaft member 12 and the outer tubular member 14, and is suitably disposed on the outer circumferential side of the center of the rubber leg 20. The outer circumferential vibration damping protrusion 32 is provided at each of the rubber legs 20, and is provided on both axial sides to protrude from both axial end surfaces of each rubber leg 20. The outer circumferential vibration damping protrusions 32 and 32 protruding in both axially outward directions from the rubber leg 20 are disposed at radial positions corresponding to each other, and these outer circumferential vibration damping protrusions 32 and 32 on both axial sides are continuously connected in the axial direction by the solidly configured rubber leg 20. The outer circumferential vibration damping protrusions 32 provided at the four rubber legs 20a, 20a, 20b, and 20b are disposed on a substantially same circumference.

The inner circumferential vibration damping protrusion 30 and the outer circumferential vibration damping protrusion 32 are disposed in parallel and separated from each other in the extending direction of the rubber leg 20. The inner circumferential vibration damping protrusion 30 and the outer circumferential vibration damping protrusion 32 are disposed at substantially even positions in the extending direction of the rubber leg 20 on the rubber leg 20. More specifically, in this embodiment, a separation distance d1 between the inner circumferential vibration damping protrusion 30 and the outer circumferential vibration damping protrusion 32 is configured to be smaller than both a distance d2 from the inner circumferential end of the rubber leg 20 to the inner circumferential vibration damping protrusion 30 (i.e., a distance from the inner circumferential vibration damping protrusion 30 to the outer circumferential surface of the inner shaft member 12) and a distance d3 from the outer circumferential end of the rubber leg 20 to the outer circumferential vibration damping protrusion 32 (i.e., a distance from the outer circumferential vibration damping protrusion 32 to the inner circumferential surface of the outer tubular member 14). The inner circumferential vibration damping protrusion 30 and the outer circumferential vibration damping protrusion 32 have thickness dimensions in the radial direction that are configured to be substantially the same as each other.

Axial positions of protruding tips of the inner circumferential vibration damping protrusion 30 and the outer circumferential vibration damping protrusion 32 are located at a substantially same position as each other. Since the axial end surface of the rubber leg 20 is configured as a tapered surface 26, as shown in FIG. 2, a length dimension in the protruding direction of the inner circumferential vibration damping protrusion 30 is configured to be smaller than a length dimension in the protruding direction of the outer circumferential vibration damping protrusion 32. Due to this difference in the protruding length dimension between the inner circumferential vibration damping protrusion 30 and the outer circumferential vibration damping protrusion 32 protruding from the rubber leg 20, the inner circumferential vibration damping protrusion 30 and the outer circumferential vibration damping protrusion 32 are set with natural frequencies different from each other. In this embodiment, the inner circumferential vibration damping protrusion 30 serve as a first vibration damping part, the outer circumferential vibration damping protrusion 32 serve as a second vibration damping part, and the first vibration damping part and the second vibration damping part are provided independently and separately from each other. In this embodiment, the natural frequency of the inner circumferential vibration damping protrusion 30 with a small protruding length dimension is set to a frequency higher than the natural frequency of the outer circumferential vibration damping protrusion 32 with a large protruding length dimension.

In the motor mount 10 having such a structure, in a state of being mounted to a vehicle, upon input of vibration from the power unit side, a vibration isolation action is exerted by elastic deformation of each rubber leg 20, and vibration transmitted to the vehicle body side is reduced.

An electric vehicle taking an electric motor as a power source may have an issue of a high dynamic spring action in a high-frequency range (e.g., 500 to 1000 Hz) resulting from surging of the rubber leg 20, which has not been a common problem in conventional automobiles taking an internal combustion engine (engine) as the power source. Thus, in the motor mount 10 of this embodiment, each rubber leg 20 is provided with the inner circumferential vibration damping protrusion 30 and the outer circumferential vibration damping protrusion 32. With the inner circumferential vibration damping protrusion 30 and the outer circumferential vibration damping protrusion 32 actively deforming in a resonant state to exert a vibration damping action as a dynamic damper, the high dynamic spring action resulting from surging of each rubber leg 20 is suppressed.

In this embodiment, by configuring the rubber leg 20 as a solid structure continuous in the axial direction, stabilization of a deformation configuration of the rubber leg 20 is achieved. As a result, stabilization of deformation configurations of the inner circumferential vibration damping protrusion 30 and the outer circumferential vibration damping protrusion 32 supported by the rubber leg 20 is achieved, and the vibration damping effect created by the inner circumferential vibration damping protrusion 30 and the outer circumferential vibration damping protrusion 32 is stably exerted.

Since the inner circumferential vibration damping protrusion 30 and the outer circumferential vibration damping protrusion 32 serve as the first vibration damping part and the second vibration damping part with natural frequencies different from each other, the vibration damping action against surging of the rubber leg 20 is exerted in a wider frequency range. In this embodiment, since the first vibration damping part and the second vibration damping part are independently provided by the inner circumferential vibration damping protrusion 30 and the outer circumferential vibration damping protrusion 32 separate from each other, a higher degree of freedom in tuning the first vibration damping part and the second vibration damping part can be obtained.

Further, since the inner circumferential vibration damping protrusion 30 and the outer circumferential vibration damping protrusion 32 are disposed separated from each other in the extending direction of the rubber leg 20, effective vibration damping effects can be obtained against not only surging of a primary vibration mode but also surging of a secondary vibration mode.

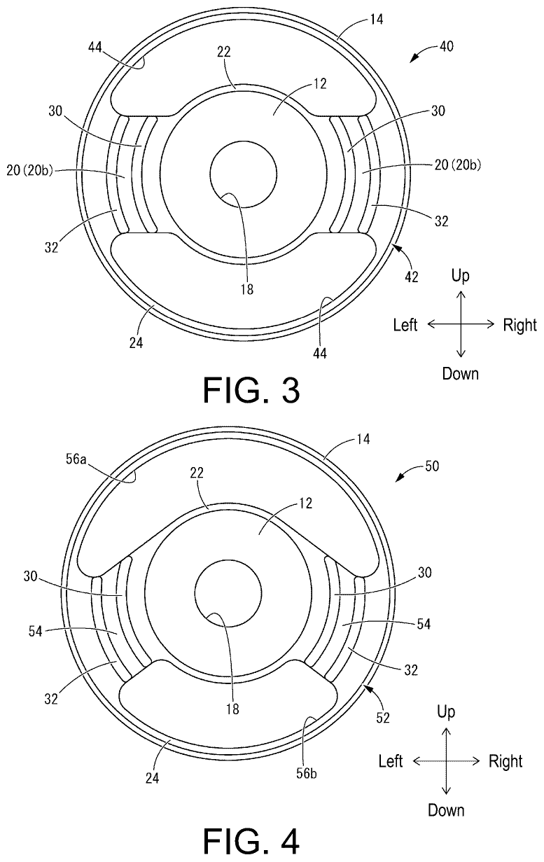

FIG. 3 shows a motor mount 40 for an electric vehicle as Second Embodiment of the tubular vibration isolation device for a motor mount according to the disclosure. The motor mount 40 has a structure in which an inner shaft member 12 and an outer tubular member 14 are connected by a main body rubber elastomer 42. In the following description, members and parts that are substantially identical to those in First Embodiment will be labeled with the same reference signs in the figures, and descriptions thereof will be omitted.

The main body rubber elastomer 42 of this embodiment includes a pair of left and right rubber legs 20b and 20b. In other words, the main body rubber elastomer 42 in this embodiment has a structure in which the upper and lower rubber legs 20a and 20a are removed from the main body rubber elastomer 16 of First Embodiment. A pair of voids 44 and 44 extending for slightly less than half a circumference in the circumferential direction are formed in circumferential intervals between the left and right rubber legs 20b and 20b (on both upper and lower sides with respect to the left and right rubber legs 20b and 20b and the inner shaft member 12).

According to the motor mount 40 of this embodiment, a soft spring property due to a shear spring of the pair of rubber legs 20b and 20b can be obtained with respect to a vibration input in the up-down direction. Further, a vibration damping effect against surging of each rubber leg 20b can be effectively obtained by the inner circumferential vibration damping protrusion 30 and the outer circumferential vibration damping protrusion 32 provided at each rubber leg 20b.

As illustrated in this embodiment, the number of rubber legs may be plural, and may be, for example, three or may be five or more. Further, the plurality of rubber legs are not necessarily required to be disposed substantially evenly in the circumferential direction, and may also be disposed unevenly in the circumferential direction.

For example, as shown in a motor mount 50 of Third Embodiment in FIG. 4, a main body rubber elastomer 52 including a pair of rubber legs 54 and 54 inclined with respect to the left-right direction may be adopted. In the motor mount 50, the pair of rubber legs 54 and 54 are inclined downward with respect to the left-right direction from the inner circumference toward the outer circumference. A relatively stiff support spring due to a compression spring component of the pair of rubber legs 54 and 54 may be obtained against a shared support load of the power unit including the electric motor (not shown), and a load-bearing performance is ensured. In the motor mount 50, upper and lower voids formed in circumferential intervals between the left and right rubber legs 54 and 54 are configured as voids 56a and 56b with shapes different due to circumferential lengths different from each other.

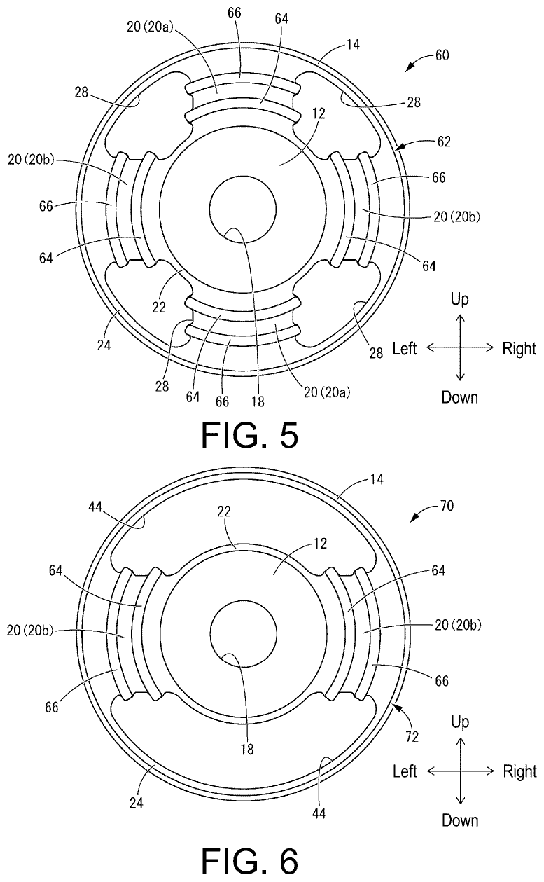

FIG. 5 shows a motor mount 60 for an electric vehicle as Fourth Embodiment of the tubular vibration isolation device for a motor mount according to the disclosure. A main body rubber elastomer 62 of the motor mount 60 includes four rubber legs 20a, 20a, 20b, and 20b disposed in a cross shape similar to First Embodiment, and each rubber leg 20 is provide with an inner circumferential vibration damping protrusion 64 and an outer circumferential vibration damping protrusion 66.

The inner circumferential vibration damping protrusion 64 protrudes respectively toward both axially outward directions from both axial end surfaces of the rubber leg 20. Further, the inner circumferential vibration damping protrusion 64 protrudes respectively toward both circumferentially outward directions from both circumferential end surfaces of the rubber leg 20. Accordingly, the inner circumferential vibration damping protrusion 64 protrudes from a full circumferential surface of the rubber leg 20 and is provided in an annular shape continuously in a full circumference of the rubber leg 20. Portions of the inner circumferential vibration damping protrusion 64 that protrude toward both circumferentially outward directions from the rubber leg 20 are continuously connected in the circumferential direction by the solidly configured rubber leg 20, and are provided continuously over an entire axial length of the rubber leg 20.

The outer circumferential vibration damping protrusion 66 protrudes respectively toward both axially outward directions from both axial end surfaces of the rubber leg 20. Further, the outer circumferential vibration damping protrusion 66 protrudes respectively toward both circumferentially outward directions from both circumferential end surfaces of the rubber leg 20. Accordingly, the outer circumferential vibration damping protrusion 66 protrudes from a full circumferential surface of the rubber leg 20 and is provided in an annular shape continuous in a full circumference of the rubber leg 20. Portions of the outer circumferential vibration damping protrusion 66 that protrude toward both circumferentially outward directions from the rubber leg 20 are continuously connected in the circumferential direction by the solidly configured rubber leg 20, and are provided continuously over an entire axial length of the rubber leg 20.

According to the motor mount 60 including such inner circumferential vibration damping protrusion 64 and outer circumferential vibration damping protrusion 66, vibration damping actions against surging of the rubber leg 20 can be obtained not only by deformation of the portions of the inner circumferential vibration damping protrusion 64 and the outer circumferential vibration damping protrusion 66 protruding toward axially outward directions from the rubber leg 20, but also by deformation of the portions of the inner circumferential vibration damping protrusion 64 and the outer circumferential vibration damping protrusion 66 protruding toward circumferentially outward directions from the rubber leg 20.

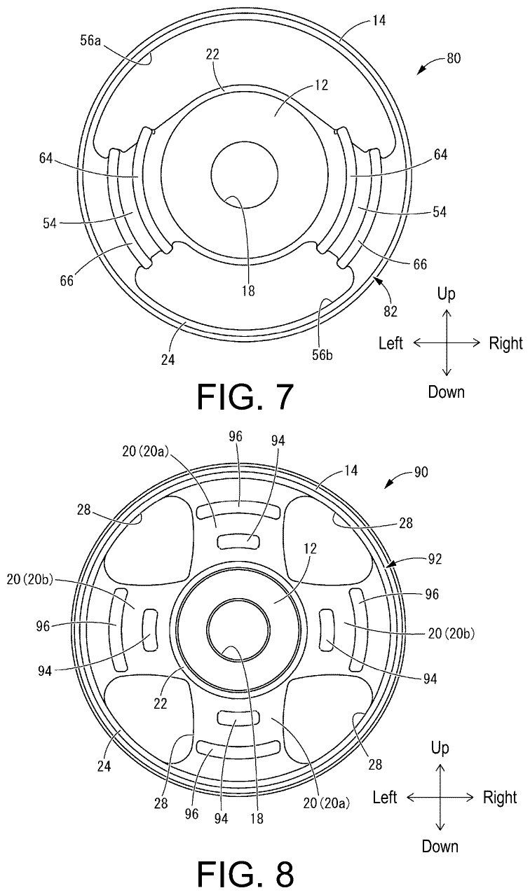

As shown in a motor mount 70 of Fifth Embodiment in FIG. 6, a main body rubber elastomer 72 may also be adopted, the main body rubber elastomer 72 having a structure combining a pair of rubber legs 20b and 20b extending in the left-right direction as in Second Embodiment, with the inner circumferential vibration damping protrusion 64 and the outer circumferential vibration damping protrusion 66. Further, as shown in a motor mount 80 of Sixth Embodiment in FIG. 7, a main body rubber elastomer 82 may also be adopted, the main body rubber elastomer 82 having a structure combining a pair of rubber legs 54 and 54 extending downward toward left and right outward directions as in Third Embodiment, with the inner circumferential vibration damping protrusion 64 and the outer circumferential vibration damping protrusion 66.

Although Fourth Embodiment to Sixth Embodiment illustrate vibration damping protrusions (64 and 66) protruding both in circumferentially outward directions and axially outward directions from the rubber leg 20 (54), it is also possible to adopt, for example, vibration damping protrusions that protrude only in circumferentially outward directions and do not protrude in the axial direction.

FIG. 8 shows a motor mount 90 for an electric vehicle as Seventh Embodiment of the tubular vibration isolation device for a motor mount according to the disclosure. A main body rubber elastomer 92 of the motor mount 90 includes four rubber legs 20a, 20a, 20b, and 20b extending in a cross shape, and has a structure in which an inner circumferential vibration damping protrusion 94 and an outer circumferential vibration damping protrusion 96 are provided at each rubber leg 20.

Each of the inner circumferential vibration damping protrusion 94 and the outer circumferential vibration damping protrusion 96 is formed into a curved plate shape extending in the circumferential direction, is integrally formed with the rubber leg 20, and protrudes toward an axially outward direction from an axial end surface of the rubber leg 20 with a substantially constant cross-sectional shape.

Compared to the outer circumferential vibration damping protrusion 96, the inner circumferential vibration damping protrusion 94 not only has a small protruding length dimension in the axial direction but also a small length dimension in the circumferential direction. Due to such differences in the shape and the size, the inner circumferential vibration damping protrusion 94 and the outer circumferential vibration damping protrusion 96 have natural frequencies configured to be different from each other. In this embodiment, the natural frequency of the inner circumferential vibration damping protrusion 94 serving as the first vibration damping part is tuned to a frequency lower than the natural frequency of the outer circumferential vibration damping protrusion 96 serving as the second vibration damping part.

As shown in this embodiment, by configuring the circumferential length dimensions of the inner circumferential vibration damping protrusion 94 and the outer circumferential vibration damping protrusion 96 to be different from each other, the natural frequencies of the inner circumferential vibration damping protrusion 94 and the outer circumferential vibration damping protrusion 96 can also be configured to be different from each other. The size relationship between the circumferential length dimension of the inner circumferential vibration damping protrusion and the circumferential length dimension of the outer circumferential vibration damping protrusion may also be reversed.

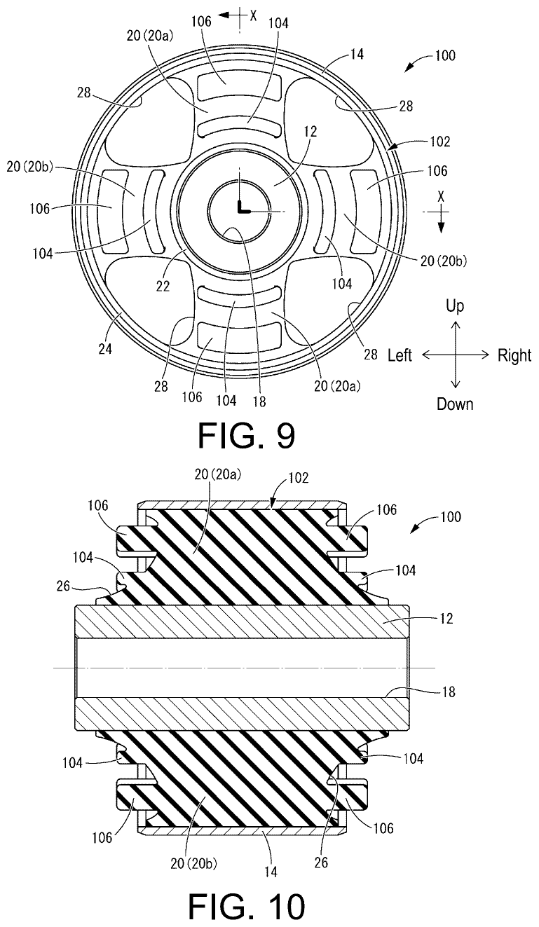

FIG. 9 and FIG. 10 show a motor mount 100 for an electric vehicle as Eighth Embodiment of the tubular vibration isolation device for a motor mount according to the disclosure. A main body rubber elastomer 102 of the motor mount 100 includes four rubber legs 20a, 20a, 20b, and 20b extending in a cross shape, and has a structure in which an inner circumferential vibration damping protrusion 104 and an outer circumferential vibration damping protrusion 106 are provided at each rubber leg 20.

The inner circumferential vibration damping protrusion 104 and the outer circumferential vibration damping protrusion 106, which are configured into curved plate shapes extending in the circumferential direction and protrude toward an axially outward direction from the rubber leg 20, have thickness dimensions in the extending direction (radial direction) of the rubber leg 20 that are different from each other, with the inner circumferential vibration damping protrusion 104 being thinner than the outer circumferential vibration damping protrusion 106. Due to such a difference in the thickness dimension between the inner circumferential vibration damping protrusion 104 and the outer circumferential vibration damping protrusion 106, the inner circumferential vibration damping protrusion 104 and the outer circumferential vibration damping protrusion 106 are set with natural frequencies different from each other. In this embodiment, the first vibration damping part and the second vibration damping part are provided independently and separately from each other by the inner circumferential vibration damping protrusion 104 and the outer circumferential vibration damping protrusion 106, and the natural frequency of the inner circumferential vibration damping protrusion 104 serving as the first vibration damping part is tuned to a frequency lower than the natural frequency of the outer circumferential vibration damping protrusion 106 serving as the second vibration damping part. The inner circumferential vibration damping protrusion 104 and the outer circumferential vibration damping protrusion 106 have thickness dimensions and protruding length dimensions in the axial direction that are different from each other as shown in FIG. 10, and have circumferential length dimensions that are configured to be substantially the same as each other as shown in FIG. 9.

As shown in this embodiment, by configuring the thickness dimensions of the inner circumferential vibration damping protrusion 104 and the outer circumferential vibration damping protrusion 106 to be different from each other, the natural frequencies of the inner circumferential vibration damping protrusion 104 and the outer circumferential vibration damping protrusion 106 can also be configured to be different from each other. The thickness dimension of the inner circumferential vibration damping protrusion may be configured to be larger than the thickness dimension of the outer circumferential vibration damping protrusion.

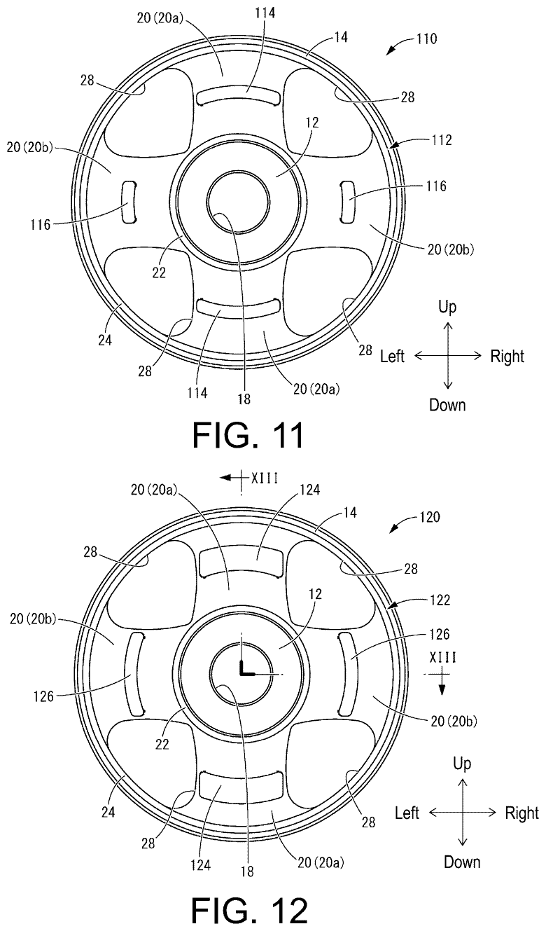

FIG. 11 shows a motor mount 110 for an electric vehicle as Ninth Embodiment of the tubular vibration isolation device for a motor mount according to the disclosure. A main body rubber elastomer 112 of the motor mount 110 includes four rubber legs 20a, 20a, 20b, and 20b disposed in a cross shape. A first vibration damping part 114 serving as a vibration damping protrusion is provided at the rubber legs 20a and 20a extending in the up-down direction, and a second vibration damping part 116 serving as a vibration damping protrusion is provided at the rubber legs 20b and 20b extending in the left-right direction.

The first vibration damping part 114 protrudes toward an axially outward direction from an axial end surface of the rubber leg 20a extending in the up-down direction, and is configured into a curved plate shape curved and extending in the circumferential direction. In this embodiment, as shown in FIG. 11, one first vibration damping part 114 alone is formed on one axial end surface of the rubber leg 20. The first vibration damping part 114 may be formed protruding on both axial sides of the rubber leg 20a, or may be provided on only one axial side of the rubber leg 20a.

The second vibration damping part 116 protrudes toward an axially outward direction from an axial end surface of the rubber leg 20b extending in the left-right direction, and is configured into a curved plate shape curved and extending in the circumferential direction. In this embodiment, as shown in FIG. 11, one second vibration damping part 116 alone is formed on one axial end surface of the rubber leg 20. The second vibration damping part 116 may be formed protruding on both axial sides of the rubber leg 20b, or may be provided on only one axial side of the rubber leg 20b.

The first vibration damping part 114 and the second vibration damping part 116 have circumferential lengths that are configured to be different from each other, and the circumferential length dimension of the first vibration damping part 114 is configured to be larger than the circumferential length dimension of the second vibration damping part 116. Accordingly, the first vibration damping part 114 and the second vibration damping part 116 have natural frequencies that are configured to be different from each other. In this embodiment, the natural frequency of the first vibration damping part 114 is tuned to a frequency lower than the natural frequency of the second vibration damping part 116.

Axial lengths of the first vibration damping part 114 and the second vibration damping part 116 may be different from each other, but are configured to be the same as each other in this embodiment. Positions of protruding tip surfaces of the first vibration damping part 114 and the second vibration damping part 116 are not particularly limited, but are set, for example, not to protrude to the axially outward direction beyond the outer tubular member 14. In this embodiment, the first vibration damping part 114 does not protrude in a circumferentially outward direction from the rubber leg 20, but may protrude toward the circumferentially outward direction from the rubber leg 20 similarly to the vibration damping protrusions (64 and 66) shown in Fourth Embodiment.

The vibration damping protrusion is not necessarily required to be provided as a plurality of vibration damping protrusions in the extending direction of the rubber leg 20. As shown in this embodiment, the vibration damping protrusion (first vibration damping part 114 and second vibration damping part 116) may also be provided at only one site in the extending direction of the rubber leg 20.

According to the motor mount 110 of this embodiment, by configuring the natural frequency of the first vibration damping parts 114 and 114 provided at the upper and lower rubber legs 20a and 20a and the natural frequency of the second vibration damping parts 116 and 116 provided at the left and right rubber legs 20b and 20b to be different from each other, a vibration damping effect against surging of the rubber leg 20 can be effectively obtained over a wider frequency range. In this embodiment, vibration damping protrusions (first vibration damping parts 114) with the same natural frequency are respectively provided at the upper and lower rubber legs 20a and 20a. However, for example, the natural frequencies of the vibration damping protrusions provided at the upper and lower rubber legs 20a and 20a may also be configured to be different from each other. Similarly, natural frequencies different from each other may also be set for the vibration damping protrusions provided at the left and right rubber legs 20b and 20b. For example, by providing vibration damping protrusions with natural frequencies different from each other respectively at the four rubber legs 20a, 20a, 20b, and 20b, it may become possible to exert an effective vibration damping action against surging in an even wider frequency range.

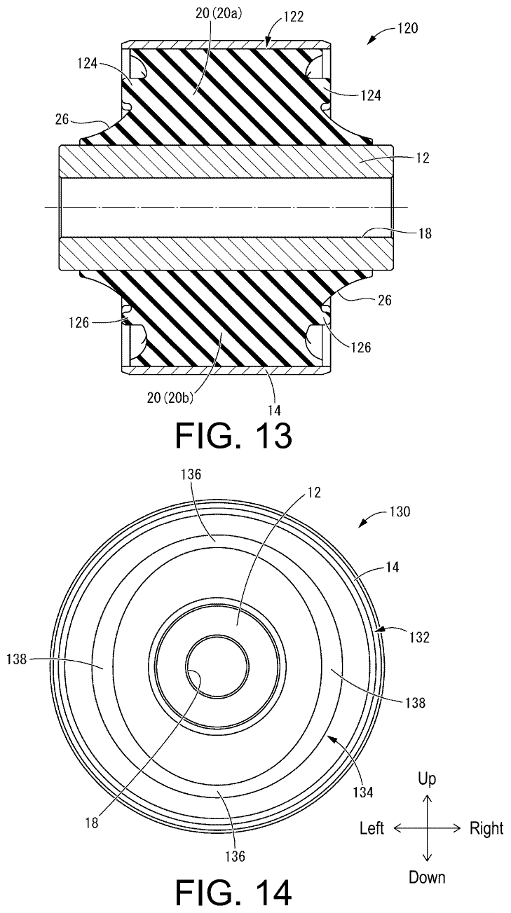

In the motor mount 110 shown in Ninth Embodiment, it has been illustrated that the first vibration damping part 114 and the second vibration damping part 116 have natural frequencies configured to be different from each other due to the difference in the circumferential length dimension. However, as shown in FIG. 12 and FIG. 13, in a main body rubber elastomer 122 of a motor mount 120 as Tenth Embodiment, vibration damping protrusions with natural frequencies different from each other may also be configured by providing a first vibration damping part 124 with a large thickness dimension at upper and lower rubber legs 20a and 20a and providing a second vibration damping part 126 with a small thickness dimension at left and right rubber legs 20b and 20b. It is also possible to configure the natural frequencies of the first vibration damping part and the second vibration damping part to be different from each other by a difference in a protruding length dimension from the rubber leg 20.

FIG. 14 shows a motor mount 130 for an electric vehicle as Eleventh Embodiment of the tubular vibration isolation device for a motor mount according to the disclosure. In the motor mount 130, a radial interval between the inner shaft member 12 and the outer tubular member 14 is connected by a main body rubber elastomer 132 over a full circumference, and the main body rubber elastomer 132 is configured into a cylindrical shape without rubber legs and voids.

A vibration damping protrusion 134 protruding toward an axially outward direction from an axial end surface is integrally formed at the main body rubber elastomer 132. The vibration damping protrusion 134 is configured into an annular shape or a tubular shape continuous in the circumferential direction, is located in a radial interval between the inner shaft member 12 and the outer tubular member 14, and is separated in the radial direction from both the inner shaft member 12 and the outer tubular member 14.

The vibration damping protrusion 134 has a thickness dimension in the radial direction that changes in the circumferential direction. Both upper and lower portions are configured as thin-walled first vibration damping parts 136, and both left and right portions configured as thick-walled second vibration damping parts 138. Specifically, in this embodiment, only one vibration damping protrusion 134 continuous in a circumferential annular shape is provided, and in the one vibration damping protrusion 134, the first vibration damping part 136 and the second vibration damping part 138 with thickness dimensions different from each other are partially provided respectively at different positions in the circumferential direction. The thickness dimension of the vibration damping protrusion 134 gradually changes in the circumferential direction, and the first vibration damping parts 136 and the second vibration damping parts 138 are continuously provided at smooth inner circumferential surface and outer circumferential surface. In the vibration damping protrusion 134 of this embodiment, with an outer circumferential surface configured into an ellipse with the major axis in the left-right direction and an inner circumferential surface configured into an ellipse with the major axis in the up-down direction, the thickness dimensions on the left and right sides are configured to be larger than the thickness dimensions on the upper and lower sides.

The first vibration damping part 136 and the second vibration damping part 138 are set with natural frequencies different from each other due to the difference in the thickness dimension in the radial direction. Accordingly, a vibration damping effect created by the vibration damping protrusion 134 (first vibration damping parts 136 and second vibration damping parts 138) against surging of the main body rubber elastomer 132 is effectively exerted in a wider frequency range.

The vibration damping protrusion 134 may also be provided on both axial sides of the main body rubber elastomer 132. In that case, in the vibration damping protrusions 134 and 134 on both axial sides, circumferential positions, quantities of formations, formation ranges in the circumferential direction, etc. of the first vibration damping part 136 and the second vibration damping part 138 may be the same as each other or may be different from each other.

For example, a plurality of annular or tubular vibration damping protrusions may be provided concentrically on a tubular main body rubber elastomer that is continuous over the full circumference as shown in this embodiment. In that case, for example, the thicknesses or the protruding lengths of the plurality of vibration damping protrusions may also be configured to be different from each other to configure natural frequencies of the plurality of vibration damping protrusions to be different from each other.

Further, in circumferentially partial vibration damping protrusions provided at a plurality of rubber legs 20, a first vibration damping part and a second vibration damping part with natural frequencies set to be different from each other due to a difference in the thickness dimension or the protruding length dimension may also be provided at each partial portion in the circumferential direction.

The vibration damping protrusion may also be set with three or more portions with natural frequencies set to be different from each other.

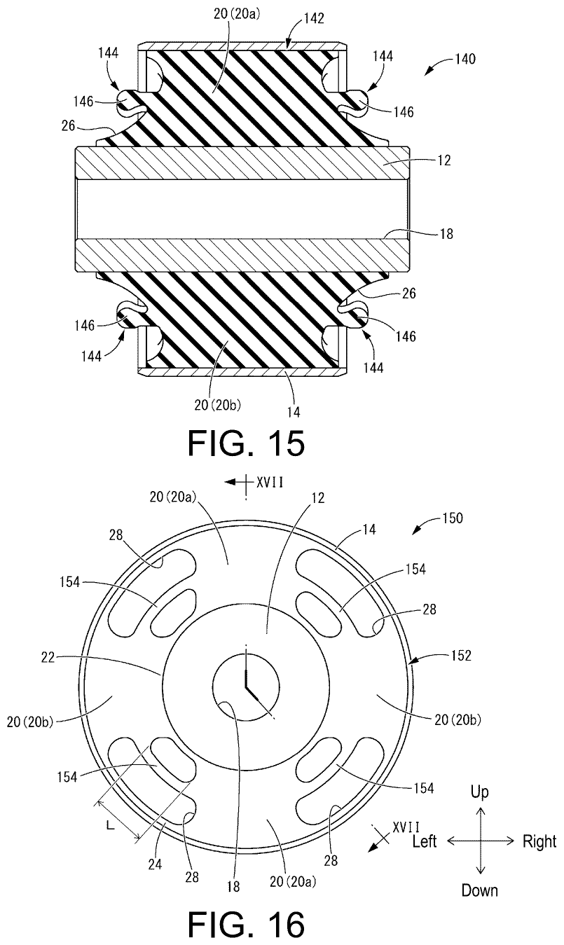

FIG. 15 shows a motor mount 140 for an electric vehicle as Twelfth Embodiment of the tubular vibration isolation device for a motor mount according to the disclosure. The motor mount 140 includes a vibration damping protrusion 144 protruding toward axially outward directions from both axial end surfaces of a main body rubber elastomer 142.

The vibration damping protrusion 144 has a thickness dimension in the radial direction that changes in the axial direction, which is the protruding direction, and a protruding tip portion is configured as a mass part 146 that is thicker than a base portion. This embodiment shows an example in which a vibration damping protrusion 144 partial in the circumferential direction is provided on the rubber legs 20a and 20b. However, the vibration damping protrusion 144 may be partially provided in the circumferential direction as in First Embodiment to Third Embodiment, or may be continuously provided over the full circumference as in Eleventh Embodiment.

By providing the mass part 146 at the protruding tip portion of the vibration damping protrusion 144, tuning of the natural frequency of the vibration damping protrusion 144 can be changed and set with a high degree of freedom according to a thickness, an axial length, etc. of the mass part 146, without changing a circumferential length or an axial protruding length of the vibration damping protrusion 144, a thickness at the base portion, etc.

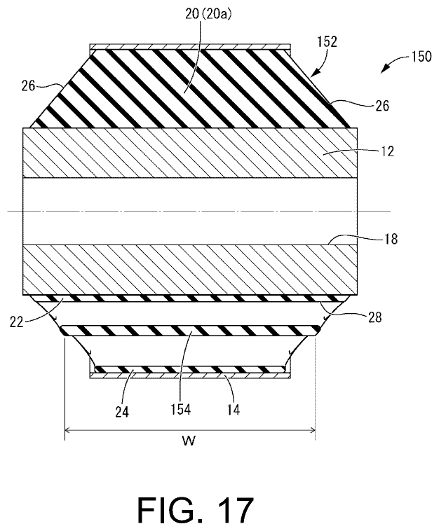

FIG. 16 and FIG. 17 show a motor mount 150 for an electric vehicle as Thirteenth Embodiment of the tubular vibration isolation device for a motor mount according to the disclosure. A main body rubber elastomer 152 of the motor mount 150 includes four rubber legs 20a, 20a, 20b, and 20b extending in a cross shape, and has a structure in which rubber legs 20a and 20b adjacent to each other in the circumferential direction are connected in the circumferential direction by a vibration damping protrusion 154.

The vibration damping protrusion 154 is configured into a curved plate shape curved and extending in the circumferential direction, and is disposed in a circumferential interval between the rubber legs 20a and 20b adjacent to each other in the circumferential direction. Both circumferential ends of the vibration damping protrusion 154 are integrally continuous with one side of each of the rubber legs 20a and 20b. In other words, the vibration damping protrusion 154 protrudes from circumferential end surfaces of the rubber legs 20a and 20b adjacent to each other in the circumferential direction, toward a circumferentially inward direction of a void 28. Both circumferential ends of the vibration damping protrusion 154 are continuous with a midway portion in the extending direction of the rubber leg 20, and the void 28 is divided into an inner circumferential side and an outer circumferential side by the vibration damping protrusion 154.

Although the vibration damping protrusion 154 may protrude in the axial direction with respect to the rubber leg 20, in this embodiment, the vibration damping protrusion 154 does not protrude in the axial direction with respect to the rubber leg 20, and an axial end surface of the vibration damping protrusion 154 constitutes a part of a tapered surface 26, which is an axial end surface of the rubber leg 20. The vibration damping protrusion 154 has a width dimension in the axial direction that is substantially constant in the circumferential direction. An axial width dimension W of a portion of the vibration damping protrusion 154 located in the circumferential interval between the rubber legs 20a and 20b is configured to be larger than a circumferential length dimension L of the portion of the vibration damping protrusion 154, and the axial width dimension W is suitably configured to be two times of more of the circumferential length dimension L.

According to such a motor mount 150 of this embodiment, surging of the rubber leg 20 is reduced or eliminated by the vibration damping protrusion 154 provided in the circumferential interval between the rubber legs 20 and 20 adjacent to each other in the circumferential direction, and high-frequency abnormal noise resulting from surging of the rubber leg 20 is prevented.

The vibration damping protrusion 154 of this embodiment is continuous with the rubber legs 20 and 20 at both circumferential ends and is supported in a both-end-supported configuration. Thus, since the vibration damping protrusion 154 has a deformation configuration different from the vibration damping protrusions (30 and 32) as in First Embodiment, which are supported in a one-end supported configuration by the rubber leg 20 only at an end on the axially inner side, it is easy to set a property different from the vibration damping protrusions (30 and 32) as in First Embodiment which protrude in the axial direction.

Two or more vibration damping protrusions 154 may also be provided separated from each other in the radial direction in the circumferential interval between the rubber legs 20a and 20b adjacent to each other in the circumferential direction. Further, it is not necessarily required to provide the vibration damping protrusion 154 in all the voids 28, and there may be cases where rubber legs 20a and 20b disposed adjacent to each other in the circumferential direction are not connected by the vibration damping protrusion 154. Further, it is also possible to adopt a combination of the vibration damping protrusion 154 which connects the rubber legs 20a and 20b in the circumferential direction as shown in this embodiment, with the vibration damping protrusion which protrudes in the axial direction from the rubber leg 20 as shown in First Embodiment and Seventh Embodiment to Tenth Embodiment.

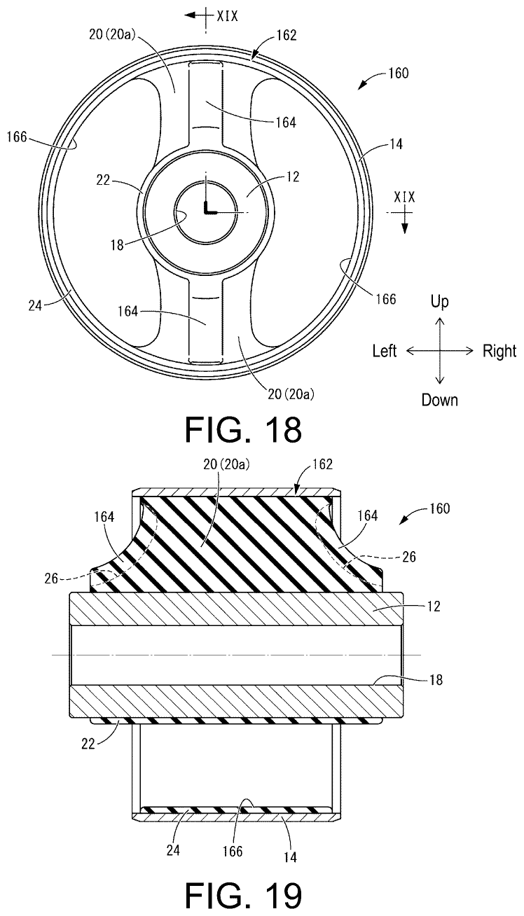

FIG. 18 and FIG. 19 show a motor mount 160 for an electric vehicle as Fourteenth Embodiment of the tubular vibration isolation device for a motor mount according to the disclosure. A main body rubber elastomer 162 of the motor mount 160 includes a pair of rubber legs 20a and 20a extending in the up-down direction, and each rubber leg 20a is provided with a vibration damping protrusion 164 protruding toward an axially outward direction from an axial end surface. A pair of voids 166 and 166 are formed in circumferential intervals between the rubber legs 20a and 20a (on both left and right sides with respect to the rubber legs 20a and 20a and the inner shaft member 12).

The vibration damping protrusion 164 is configured into a plate shape extending in a straight line in the connecting direction (i.e., the extending direction of the rubber leg 20a) of the rubber leg 20a connecting the inner shaft member 12 and the outer tubular member 14. In this embodiment, the vibration damping protrusion 164 has an inner circumferential end integrally continuous with an inner circumferential connecting part 22, and an outer circumferential end integrally continuous with an outer circumferential connecting part 24. Further, each vibration damping protrusion 164 in this embodiment has a constant circumferential width dimension smaller than a circumferential width dimension of the rubber leg 20a, and extends in a straight line toward the radial direction over a center in the width direction (circumferential direction) of the axial end surface of the rubber leg 20a, with a radial length dimension larger than the circumferential width dimension. In the motor mount 160 of this embodiment, a main vibration input direction in a vehicle-mounted state is the left-right direction, and the extending direction of the vibration damping protrusion 164 is substantially perpendicular to the main vibration input direction. In this manner, if the extending direction of the vibration damping protrusion 164 is a direction perpendicular to the main vibration input direction, since the vibration damping protrusion 164 undergoes shear deformation during input of the main vibration, distortion of the vibration damping protrusion 164 is reduced compared to cases where the vibration damping protrusion 164 is compressed in the extending direction.

According to such a vibration damping protrusion 164 extending in the extending direction of the rubber leg 20a, effective vibration damping effects can be expected against not only surging of a primary vibration mode but also surging of a multiple-order vibration mode. Specifically, in the multiple-order vibration mode, although the amplitude of bending deformation of the rubber leg 20a becomes large at a plurality of sites in the extending direction of the rubber leg 20a, since the vibration damping protrusion 164 extending in the extending direction of the rubber leg 20a is located at any of the plurality of sites (portions that become antinodes of the vibration mode) at which the bending deformation of the rubber leg 20a becomes large, a vibration damping effect is efficiently exerted. The vibration damping protrusion 164 is not required to extend strictly in the extending direction (radial direction) of the rubber leg 20a. As long as the vibration damping protrusion 164 extends in the extending direction of the rubber leg 20a as a whole, the vibration damping protrusion 164 may also be inclined or curved with respect to the extending direction of the rubber leg 20a, or may have a circumferential width dimension that changes. Further, it is also possible to provide a plurality of vibration damping protrusions 164 separated from each other in the circumferential direction on the axial end surface of the rubber leg 20a.

Although the embodiments of the disclosure have been described in detail above, the disclosure is not limited to the specific descriptions thereof. For example, the plurality of rubber legs may be formed with vibration damping protrusions in shapes different from each other, may be formed with vibration damping protrusions in quantities different from each other, or may be provided with vibration damping protrusions in arrangements different from each other.

In the case of providing a plurality of vibration damping protrusions, the natural frequencies of the vibration damping protrusions may be set to be the same as each other.

The structures shown in First Embodiment to Fourteenth Embodiment may be adopted in combination as appropriate. In other words, for example, the vibration damping protrusions shown in different embodiments may also be applied in combination.

The vibration damping protrusion is not limited to a plate shape, but may also be in a rod shape and the like provided to protrude spotwise, for example. Further, the vibration damping protrusion provided to spread in the circumferential direction is not necessarily required to be curved and extend in the circumferential direction, and may also be in a flat plate shape, or may also be curved to be inclined to the outer circumference toward the circumferentially outward direction.

In the case where the main body rubber elastomer includes a plurality of rubber legs, it is not required to provide the vibration damping protrusion at all of the plurality of rubber legs. The vibration damping protrusion may be provided at one or some of the plurality of rubber legs, with the other rubber legs not provided with the vibration damping protrusion.

In a main body rubber elastomer with a continuous structure in the full circumference without rubber legs as shown in FIG. 14, the vibration damping protrusion may also be partially provided in the circumferential direction. In that case, a plurality of vibration damping protrusions that are separated from each other in the circumferential direction may be provided.

At least one of the inner shaft member 12 and the outer tubular member 14 may be mounted to the main body rubber elastomer 16 without bonding. The inner shaft member 12 and the outer tubular member 14 may have radial centers (central axes) that are misaligned with each other, or may have axial centers that are misaligned with each other.

What is claimed is:

1. A tubular vibration isolation device for a motor mount, comprising an inner shaft member and an outer tubular member that are connected by a main body rubber elastomer, wherein
the main body rubber elastomer comprises a plurality of rubber legs that extend from the inner shaft member toward the outer tubular member to connect the inner shaft member and the outer tubular member to each other,
the rubber leg is provided with a plurality of vibration damping protrusions that protrude on a surface and are located at an intermediate portion separated from both the inner shaft member and the outer tubular member in a connecting direction, and
the plurality of vibration damping protrusions are disposed in parallel and separated from each other in the connecting direction of the rubber leg.

2. The tubular vibration isolation device for a motor mount according to claim 1, wherein the plurality of vibration damping protrusions provided at the rubber leg are set with a plurality of natural frequencies different from each other.

3. The tubular vibration isolation device for a motor mount according to claim 2, wherein the plurality of natural frequencies different from each other are set by configuring protruding dimensions of the vibration damping protrusions protruding from the rubber leg to be different from each other.

4. The tubular vibration isolation device for a motor mount according to claim 2, wherein the plurality of natural frequencies different from each other are set by configuring thickness dimensions in a radial direction of the vibration damping protrusions to be different from each other.

5. The tubular vibration isolation device for a motor mount according to claim 1, wherein the plurality of vibration damping protrusions are disposed substantially evenly in the connecting direction of the rubber leg on the rubber leg.

6. The tubular vibration isolation device for a motor mount according to claim 1, wherein the vibration damping protrusions disposed adjacent to each other in the connecting direction of the rubber leg are separated from each other by a distance that is configured to be smaller than both of a distance from the vibration damping protrusion located at an innermost circumference to an inner circumferential end of the rubber leg, and a distance from another vibration damping protrusion located at an outermost circumference to an outer circumferential end of the rubber leg.

7. The tubular vibration isolation device for a motor mount according to claim 1, wherein the rubber leg is configured as a solid structure that continuously extends from axial central portions of the inner shaft member and the outer tubular member toward both axial sides respectively, and
the vibration damping protrusion protrudes from both axial end surfaces of the rubber leg toward axially outward directions respectively, and the vibration damping protrusions on the both axial sides protruding from the both axial end surfaces are continuously connected in an axial direction by the rubber leg.

8. The tubular vibration isolation device for a motor mount according to claim 1, wherein the rubber leg is configured as a solid structure that continuously extends from axial central portions of the inner shaft member and the outer tubular member toward both axial sides respectively, and
the vibration damping protrusion protrudes from both circumferential end surfaces of the rubber leg respectively, and is continuously provided over an entire axial length of the rubber leg.

9. The tubular vibration isolation device for a motor mount according to claim 1, wherein the rubber leg is configured as a solid structure that continuously extends from axial central portions of the inner shaft member and the outer tubular member toward both axial sides respectively, and
the vibration damping protrusion protrudes from a full circumferential surface of the rubber leg and is continuously provided in an annular shape.

10. A tubular vibration isolation device for a motor mount, comprising an inner shaft member and an outer tubular member that are connected by a main body rubber elastomer, wherein
the main body rubber elastomer comprises a plurality of rubber legs that extend from the inner shaft member toward the outer tubular member to connect the inner shaft member and the outer tubular member to each other,
in a circumferential interval between the rubber legs adjacent to each other in a circumferential direction, at least one vibration damping protrusion is provided to connect the rubber legs to each other in the circumferential direction, and
the vibration damping protrusion has an axial dimension that is configured to be larger than a circumferential dimension at a portion located in the circumferential interval between the rubber legs.

11. The tubular vibration isolation device for a motor mount according to claim 10, wherein the vibration damping protrusion has both axial ends that do not protrude toward axially outward directions with respect to axial end surfaces of the rubber leg.

12. A tubular vibration isolation device for a motor mount, comprising an inner shaft member and an outer tubular member that are connected by a main body rubber elastomer, wherein
the main body rubber elastomer comprises a plurality of rubber legs that extend from the inner shaft member toward the outer tubular member to connect the inner shaft member and the outer tubular member to each other,
the rubber leg is provided with at least one vibration damping protrusion that protrudes on a surface, and
the vibration damping protrusion extends in a connecting direction of the rubber leg.

13. A tubular vibration isolation device for a motor mount, comprising an inner shaft member and an outer tubular member that are connected by a main body rubber elastomer, wherein
the main body rubber elastomer is provided with at least one vibration damping protrusion that protrudes on a surface and is located at an intermediate portion separated from both the inner shaft member and the outer tubular member in a radial direction, and
the vibration damping protrusion constitutes a first vibration damping part and a second vibration damping part with natural frequencies different from each other.

14. The tubular vibration isolation device for a motor mount according to claim 13, wherein the first vibration damping part and the second vibration damping part are constituted by separate vibration damping protrusions.

15. The tubular vibration isolation device for a motor mount according to claim 13, wherein the first vibration damping part and the second vibration damping part are constituted by different portions of one vibration damping protrusion.

16. A tubular vibration isolation device for a motor mount, comprising an inner shaft member and an outer tubular member that are connected by a main body rubber elastomer, wherein
the main body rubber elastomer is provided with at least one vibration damping protrusion that protrudes in an axially outward direction on a surface of an axial end, and
the vibration damping protrusion comprises a mass part that is configured to be thick at a tip portion of a protruding direction.
